(19) United States
(12) Patent Application Publication
(10) Pub. No.: US 2007/0102177 A1
(43) Pub. Date: May 10, 2007

(54) Combined torque indicator and regulator for pneumatically-operated hand tool

(76) Inventor: Omar P.J. Lee, Lakewood, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 11/269,295

(22) Filed: Nov. 9, 2005

(51) Int. Cl. B23Q 5/00

(52) U.S. Cl. 173/176

(57) ABSTRACT

A power tool includes a pneumatic torque wrench that has a first housing provided with a threaded aperture and a second housing that is in fluid communication with the first housing such that air passes through the housings. A male coupling is conjoined to the first housing threaded aperture. A coupling assembly is connected to the second housing and conjoined to the lug nut. The coupling assembly includes a first coupling that has a threaded outer surface conjoined to the second housing. A second coupling has a proximal end provided with a threaded inner surface that is connected to the first coupling and a distal end provided with a threaded outer surface, having a fastener threadably mated therewith. A mechanism is included for regulating a pressure level of the air such that a torque level generated by the second housing can be identified and regulated by the operator.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to pneumatic hand tools and, more particularly, to a combined torque indicator and regulator for pneumatically-operated hand tools.

2. Prior Art

Mechanics and other professionals in the automotive industry, as well as many other industries and occupations, are quite familiar with the fatigue one experiences after repeated loosening and fastening nuts, bolts and screws. Repeated rotation of the forearm can lead to such severe muscle pains that the individual's work is negatively affected. In response to this dilemma the concept of pneumatically operated tools was introduced to the prior art.

Pneumatically operated tools, as the name suggests, employs air to provide the rotational movement that is usually manually applied to the tools. Such tools have greatly improved the efficiency and speed with which many task are performed. For example, the lug nuts of a vehicle's wheel can be loosened in a matter of seconds using such a tools as opposed to taking one or two minutes to manually remove the same lug nuts.

Certain fasteners, such as nuts, bolts and screws that are employed in a vehicle must be tightened at a very specific torque in order for proper operation of the components that are held together thereby. When manually attaching the parts it is quite simple to tighten the fastener until the desired torque is applied thereto. However, as mentioned herein above, this can be quite a time-consuming task, especially in an industry where expediency can greatly increase one's profit line. Unfortunately, the ability to effectively and accurately control the torque on a fastener is lost when employing a pneumatically operated tool.

Accordingly, a need remains for a torque indicator for pneumatically-operated hand tools in order to overcome the above-noted shortcomings. The present invention satisfies such a need by providing a pneumatic tool that is easy and convenient to use, small in size and efficient in application. Such a tool is attachable to an air-supply source in a matter of seconds and helps prevent the air hose from becoming tangled during use. The pressure regulator thereof advantageously provides a convenient means of adjusting and regulating the torque that is applied by the tool. This, in turn, prevents fasteners from being under- or over-tightened when using the combined torque indicator and regulator for a pneumatically-operated hand tool.

### BRIEF SUMMARY OF THE INVENTION

In view of the foregoing background, it is therefore an object of the present invention to provide a combined torque indicator and regulator for a pneumatically-operated hand tool. These and other objects, features, and advantages of the invention are provided by a combined torque identifying accessory and associated power tool for assisting an operator to control a pressure level applied to a lug nut when assembling and disassembling a vehicle tire.

The combined torque identifying accessory and power tool includes a pneumatically operated torque wrench that has a first housing provided with a threaded aperture extending parallel to a centrally registered longitudinal axis thereof. Such a first housing preferably has surface indicia printed thereon. The surface indicia provides a uniform scale that conveniently designates the torque level based upon the air-pressure level existing within the first and second housings during operating conditions. The torque wrench further has a second housing that has a centrally registered longitudinal axis registered orthogonal to the first housing axis. Such a second housing is in fluid communication with the first housing such that a predetermined volume of air passes through the first and second housings. The first and second housings are selectively pivotal about the first housing axis.

A male coupling is threadably conjoined directly to the threaded aperture of the first housing wherein the air is introduced through the male coupling and channeled linearly through the first housing. Such air is forced out of the first housing and into the second housing along a path oriented parallel to the second housing axis. The male coupling may be removably conjoined to the first housing.

A coupling assembly is threadably connected directly to the second housing and operably conjoined directly to the lug nut for rotating the lug nut between clockwise and counter clockwise directions. Such a coupling assembly includes a first coupling that has a threaded outer surface directly conjoined to the second housing. A second coupling has a proximal end provided with a threaded inner surface that is directly connected to the first coupling. Such a second coupling has a distal end provided with a threaded outer surface. A fastener is directly and threadably mated with the distal end of the second coupling. Such a fastener is conveniently and effectively attachable to the lug nut.

A mechanism is included for effectively regulating a pressure level of the air after the air is introduced through the male coupling such that a torque level generated by the second housing can advantageously be visually identified and regulated by the operator when the lug nut is being attached and detached from the vehicle tire. Such an air pressure level regulating mechanism preferably includes a turn dial that includes an elongated linear shaft directly attached thereto. The turn dial preferably includes a pointer imprinted thereon. The shaft has a first end statically and directly connected to the turn dial. Such a shaft traverses through the first housing and further has a second end terminating within the second housing. The shaft is oriented parallel to the second housing axis.

A plurality of auxiliary bearings are intercalated between an external surface of the shaft and an inner surface of the second housing for effectively allowing the shaft to rotate a predetermined distance about the second housing axis based upon the air-pressure level. An axial bore is linearly formed within the shaft. A primary bearing is disposed generally medially of the shaft and confronts a proximal closed face of the bore.

A first resilient spring member is interfitted within the bore and is horizontally disposed therein such that the spring member effectively adapts between compressed and expanded positions along a linear path defined parallel to the second housing axis. Such a first spring member is directly abutted against the primary bearing. An elongated stop member has a first end portion that is directly conjoined to the resilient spring member and further has a second end portion that terminates beyond the distal end portion of the shaft.

A second resilient spring member is anchored to the second housing and is linearly aligned with the stop member. Such a second end portion of the stop member is directly conjoined to the second spring member such that the stop member is effectively caused to rebound along the linear path between the first and second spring members when the air-pressure level is fluctuated during operating conditions.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a perspective view showing a combined torque indicator and regulator for pneumatically-operated hand tools, in accordance with the present invention;

FIG. 2 is a front-elevational view of the device shown in FIG. 1;

FIG. 3 is a cross-sectional view of the device shown in FIG. 2, taken along line 3-3;

FIG. 4 is an exploded perspective view of the device shown in FIG. 1;

FIG. 5 is a top plan view of the second housing shown in FIG. 4; and

FIG. 6 is a cross-sectional view of the second housing shown in FIG. 5, taken along line 6-6.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

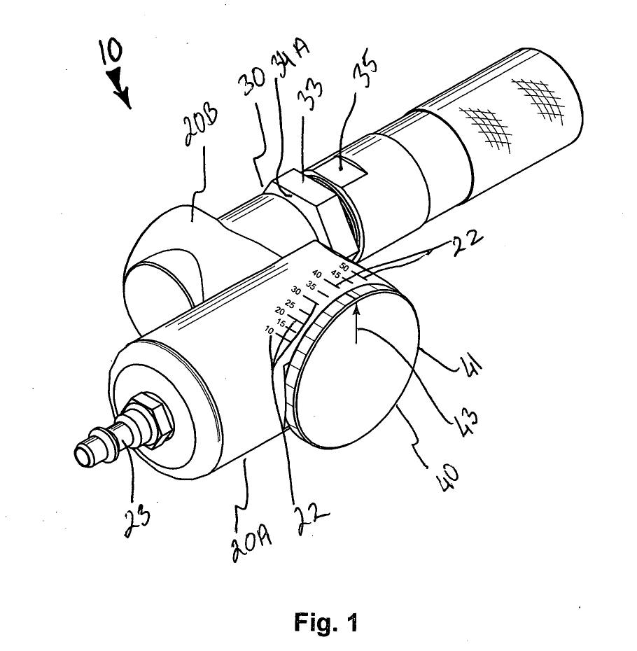

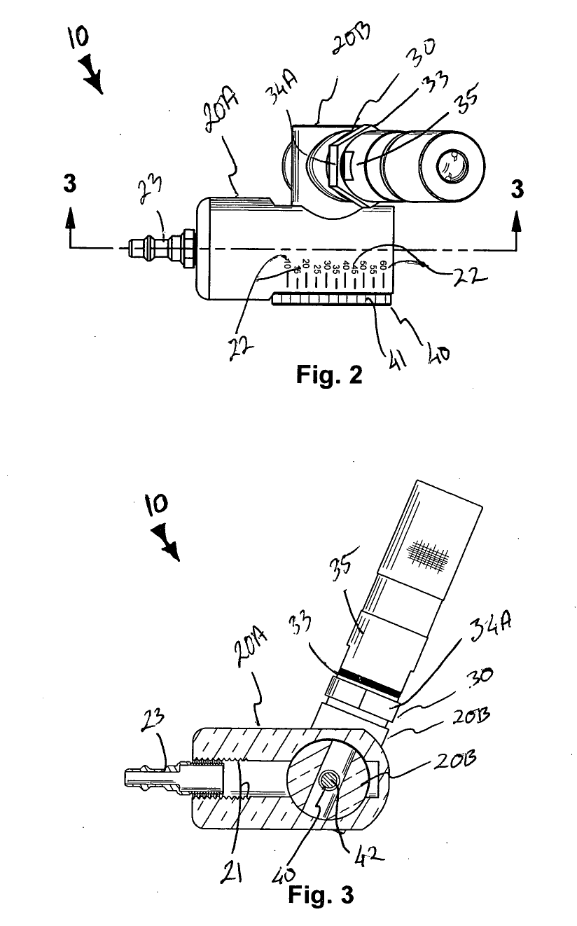

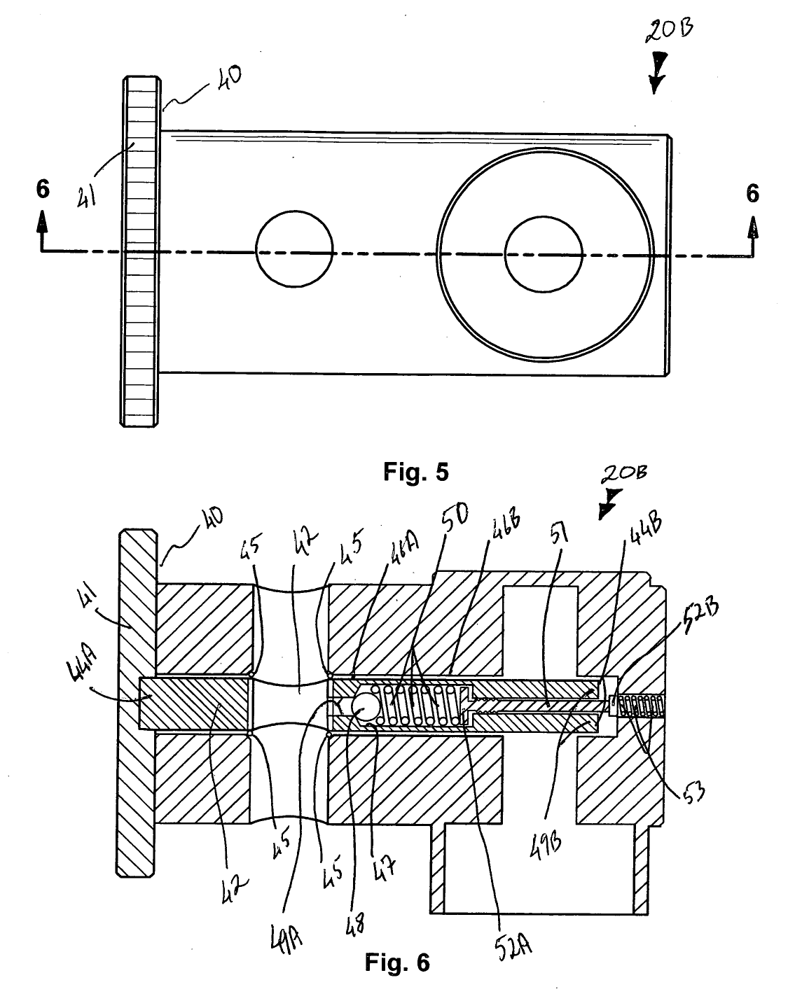

The device of this invention is referred to generally in FIGS. 1-6 by the reference numeral 10 and is intended to provide a combined torque indicator and regulator for pneumatically-operated hand tools. It should be understood that the device 10 may be used to pneumatically fasten many different types of fasteners and should not be limited in use to only wheel lug nuts.

Referring initially to FIGS. 1 through 6, the device 10 includes a pneumatically operated torque wrench that has a first housing 20A provided with a threaded aperture 21 extending parallel to a centrally registered longitudinal axis thereof. Such a first housing 20A has surface indicia 22 printed thereon that are essential for effectively allowing a user to conveniently visually identify the torque setting of the device 10. The surface indicia 22 provides a uniform scale that conveniently designates the torque level based upon the air-pressure level existing within the first 20A and second 20B (described herein below) housings during operating conditions.

The torque wrench 10 further has a second housing 20B that has a centrally registered longitudinal axis registered orthogonal to the first housing axis. Such a second housing 20B is in fluid communication with the first housing 20A, which is crucial such that a predetermined volume of air effectively passes through the first 20A and second 20B housings. The first 20A and second 20B housings are selectively pivotal about the first housing axis.

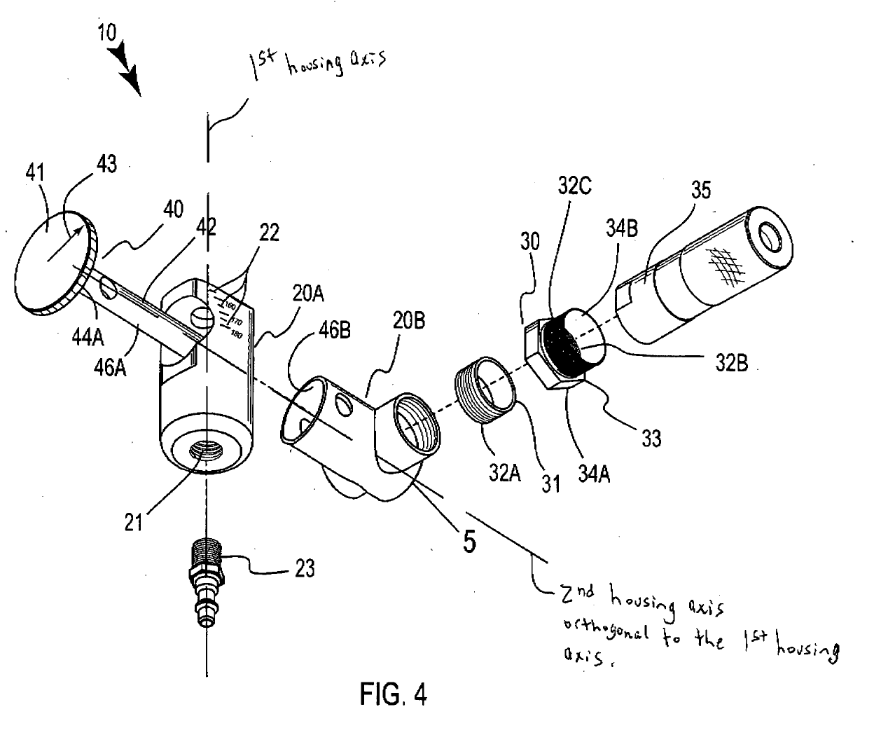

Referring to FIGS. 1 through 4, a male coupling 23 is threadably conjoined directly, without the use of intervening elements, to the threaded aperture 21 of the first housing 20A wherein the air is introduced through the male coupling 23 and channeled linearly through the first housing 20A. Of course, the male coupling 23 may be alternately positioned and still allow air to be introduced into the first housing 20A, as is obvious to a person of ordinary skill in the art. Such air is forced out of the first housing 20A and into the second housing 20B along a path oriented parallel to the second housing axis. The male coupling 23 is removably conjoined to the first housing 20A, as is best shown in FIG. 4.

Again referring to FIGS. 1 through 4, a coupling assembly 30 is threadably connected directly, without the use of intervening elements, to the second housing 20B and operably conjoined directly, without the use of intervening elements, to the lug nut (not shown) for conveniently and effectively rotating the lug nut between clockwise and counter clockwise directions. Such a coupling assembly 30 includes a first coupling 31 that has a threaded outer surface 32A directly conjoined, without the use of intervening elements, to the second housing 20B.

A second coupling 33 has a proximal end 34A provided with a threaded inner surface 32B that is directly connected, without the use of intervening elements, to the first coupling 31. Such a second coupling 33 has a distal end 34B provided with a threaded outer surface 32C. A fastener 35 is directly and threadably mated, without the use of intervening elements, with the distal end 34B of the second coupling 33. Such a fastener 35 is conveniently and effectively attachable to the lug nut. Of course, the device 10 may employ a variety of fasteners 35 for fastening a loosening a plethora of alternate nuts, bolts and screws, as is obvious to a person of ordinary skill in the art.

Referring to FIGS. 1 through 6, a mechanism 40 is included for effectively regulating a pressure level of the air after the air is introduced through the male coupling 23, which is important such that a torque level generated by the second housing 20B can advantageously be visually identified and regulated by the operator when the lug nut is being attached and detached from the vehicle tire (not shown). Thus, the operator can be sure that the lug nut is properly fastened without jeopardizing the integrity of the wheel or the lug nut. Such an air pressure level regulating mechanism 40 includes a turn dial 41 that includes an elongated linear shaft 42 directly attached, without the use of intervening elements, thereto.

The turn dial 41 includes a pointer 43 imprinted thereon that is crucial and convenient for visually indicating the torque setting of the device 10 by pointing to the surface indicia 22. The shaft 42 has a first end 44A statically and directly connected, without the use of intervening elements, to the turn dial 41. Such a shaft 42 traverses through the first housing 20A and further has a second end 44B terminating within the second housing 20B. The shaft 42 is oriented parallel to the second housing axis.

Referring to FIG. 6, a plurality of auxiliary bearings 45 are intercalated between an external surface 46A of the shaft 42 and an inner surface 46B of the second housing 20B, which is vital for effectively allowing the shaft 42 to rotate a predetermined distance about the second housing axis based upon the air-pressure level. An axial bore 47 is linearly formed within the shaft 42. A primary bearing 48 is disposed generally medially of the shaft 42 and confronts a proximal closed face 49A of the bore 47.

Still referring to FIG. 6, a first resilient spring member 50 is interfitted within the bore 47 and is horizontally disposed therein such that the spring member 50 effectively adapts between compressed and expanded positions along a linear path defined parallel to the second housing axis. Such a first spring member 50 is directly abutted, without the use of intervening elements, against the primary bearing 48. An elongated stop member 51 has a first end portion 52A that is directly conjoined, without the use of intervening elements, to the resilient spring member 50 and further has a second end portion 52B that terminates beyond the distal end portion 49B of the shaft 42.

Again referring to FIG. 6, a second resilient spring member 53 is anchored to the second housing 20B and is linearly aligned with the stop member 51. Such a second end portion 52B of the stop member 51 is directly conjoined, without the use of intervening elements, to the second spring member 53, which is critical such that the stop member 51 is effectively caused to rebound along the linear path between the first 50 and second 53 spring members when the air-pressure level is fluctuated during operating conditions.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

1. A combined torque identifying accessory and associated power tool for assisting an operator to control a pressure level applied to a lug nut when assembling and disassembling a vehicle tire, said combined torque identifying accessory and power tool comprising:
a pneumatically operated torque wrench having a first housing provided with a threaded aperture extending parallel to a centrally registered longitudinal axis thereof, said torque wrench further having a second housing having a centrally registered longitudinal axis registered orthogonal to said first housing axis, said second housing being in fluid communication with said first housing such that a predetermined volume of air passes through said first and second housings;
a male coupling threadably conjoined directly to said threaded aperture of said first housing wherein said air is introduced through said male coupling and channeled linearly through said first housing, said air being forced out of said first housing and into said second housing along a path oriented parallel to said second housing axis;
a coupling assembly threadably connected directly to said second housing and operably conjoined to the lug nut; and
means for regulating a pressure level of said air after said air is introduced through said male coupling such that a torque level generated by said second housing can be visually identified and regulated by the operator when the lug nut is being attached and detached from the vehicle tire;
wherein said air pressure level regulating means comprises
a turn dial including an elongated linear shaft directly attached thereto, said shaft having a first end statically and directly connected to said turn dial, said shaft traversing through said first housing and further having a second end terminating within said second housing said shaft being oriented parallel to said second housing axis;
a plurality of auxiliary bearings intercalated between an external surface of said shaft and an inner surface of said second housing for allowing said shaft to rotate a predetermined distance about said second housing axis based upon said air-pressure level;
an axial bore linearly formed within said shaft;
a primary bearing disposed generally medially of said shaft and confronting a proximal closed face of said bore;
a first resilient spring member interfitted within said bore and horizontally disposed therein such that said spring member adapts between compressed and expanded positions along a linear path defined parallel to said second housing axis, said first spring member being directly abutted against said primary bearing;
an elongated stop member having a first end portion directly conjoined to said resilient spring member and further having a second end portion terminating beyond said distal end portion of said shaft; and
a second resilient spring member anchored to said second housing and linearly aligned with said stop member, said second end portion of said stop member being directly conjoined to said second spring member such that said stop member is caused to rebound along said linear path and between said first and second spring members when said air-pressure level is fluctuated during operating conditions.

2. (canceled)

3. The device of claim 1, wherein said first housing has surface indicia printed thereon, said surface indicia providing a uniform scale that designates said torque level based upon said air-pressure level existing within said first and second housings during operating conditions.

4. The device of claim 1, wherein said male coupling is removably conjoined to said first housing.

5. The device of claim 1, wherein said turn dial includes a pointer imprinted thereon.

6. A combined torque identifying accessory and associated power tool for assisting an operator to control a pressure level applied to a lug nut when assembling and disassembling a vehicle tire, said combined torque identifying accessory and power tool comprising:
a pneumatically operated torque wrench having a first housing provided with a threaded aperture extending parallel to a centrally registered longitudinal axis thereof, said torque wrench further having a second housing having a centrally registered longitudinal axis registered orthogonal to said first housing axis, said second housing being in fluid communication with said first housing such a predetermined volume of air passes through said first and second housings;
a male coupling threadably conjoined directly to said threaded aperture of said first housing wherein said air is introduced through said male coupling and channeled linearly through said first housing, said air being forced out of said first housing and into said second housing along a path oriented parallel to said second housing axis;
a coupling assembly threadably connected directly to said second housing and operably conjoined to the lug nut; wherein said coupling assembly comprises:
a first coupling having a threaded outer surface directly conjoined to said second housing;
a second coupling having a proximal end provided with a threaded inner surface directly connected to said first coupling, said second coupling having a distal end provided with a threaded outer surface; and
a fastener directly and threadably mated with said distal end of said second coupling, said fastener being conjoined with said second housing in order to rotate the lug nut; and
means for regulating a pressure level of said air after said is introduced through said male coupling such that a torque level generated by said second housing can be visually identified and regulated by the operator when the lug nut is being attached and detached from the vehicle tire;
wherein said air pressure level regulating means comprises
a turn dial including an elongated linear shaft directly attached thereto, said shaft having a first end statically and directly connected to said turn dial, said shaft traversing through said first housing and further having a second end terminating within said second housing, said shaft being oriented parallel to said second housing axis;
a plurality of auxiliary bearings intercalated between an external surface of said shaft and an inner surface of said second housing for allowing said shaft to rotate a predetermined distance about said second housing axis based upon said air-pressure level;
an axial bore linearly formed within said shaft;
a primary bearing disposed generally medially of said shaft and confronting a proximal closed face of said bore;
a first resilient spring member interfitted within said bore and horizontally disposed therein such that said spring member adapts between compressed and expanded positions along a linear path defined parallel to said second housing axis, said first spring member being directly abutted against said primary bearing;
an elongated stop member having a first end portion directly conjoined to said resilient spring member and further having a second end portion terminating beyond said distal end, portion of said shaft; and
a second resilient spring member anchored to said second housing and linearly aligned with said stop member, said second end portion of said stop member being directly conjoined to said second spring member such that said stop member is caused to rebound along said linear path and between said first and second spring members when said air-pressure level is fluctuated during operating conditions.

7. (canceled)

8. The device of claim 6, wherein said first housing has surface indicia printed thereon, said surface indicia providing a uniform scale that designates said torque level based upon said air-pressure level existing within said first and second housings during operating conditions.

9. The device of claim 6, wherein said male coupling is removably conjoined to said first housing.

10. The device of claim 6, wherein said turn dial includes a pointer imprinted thereon.

11. A combined torque identifying accessory and associated power tool for assisting an operator to control a pressure level applied to a lug nut when assembling and disassembling a vehicle tire, said combined torque identifying accessory and power tool comprising:
a pneumatically operated torque wrench having a first housing provided with a threaded aperture extending parallel to a centrally registered longitudinal axis thereof, said torque wrench further having a second housing having a centrally registered longitudinal axis registered orthogonal to said first housing axis, said second housing being in fluid communication with said first housing such a predetermined volume of air passes through said first and second housings, said first and second housings are selectively pivotal about said first housing axis;
a male coupling threadably conjoined directly to said threaded aperture of said first housing wherein said air is introduced through said male coupling and channeled linearly through said first housing, said air being forced out of said first housing and into said second housing along a path oriented parallel to said second housing axis;
a coupling assembly threadably connected to said second housing; wherein said coupling assembly comprises:
a first coupling having a threaded outer surface directly conjoined to said second housing;
a second coupling having a proximal end provided with a threaded inner surface directly connected to said first coupling, said second coupling having a distal end provided with a threaded outer surface; and
a fastener directly and threadably mated with said distal end of said second coupling, said fastener being conjoined with said second housing in order to rotate the lug nut; and
means for regulating a pressure level of said air after said is introduced through said male coupling such that a torque level generated by said second housing can be visually identified and regulated by the operator when the lug nut is being attached and detached from the vehicle tire;
wherein said air pressure level regulating means comprises
a turn dial including an elongated linear shaft directly attached thereto, said shaft having a first end statically and directly connected to said turn dial, said shaft traversing through said first housing and further having a second end terminating within said second housing, said shaft being oriented parallel to said second housing axis;
a plurality of auxiliary bearings intercalated between an external surface of said shaft and an inner surface of said second housing for allowing said shaft to rotate a predetermined distance about said second housing axis based upon said air-pressure level;
an axial bore linearly formed within said shaft;
a primary bearing disposed generally medially of said shaft and confronting a proximal closed face of said bore;
a first resilient spring member interfitted within said bore and horizontally disposed therein such that said spring member adapts between compressed and expanded positions along a linear path defined parallel to said second housing axis, said first spring member being directly abutted against said primary bearing;
an elongated stop member having a first end portion directly conjoined to said resilient spring member and further having a second end portion terminating beyond said distal end portion of said shaft; and
a second resilient spring member anchored to said second housing and linearly aligned with said stop member, said second end portion of said stop member being directly conjoined to said second spring member such that said stop member is caused to rebound along said linear path and between said first and second spring members when said air-pressure level is fluctuated during operating conditions.

12. (canceled)

13. The device of claim 11, wherein said first housing has surface indicia printed thereon, said surface indicia providing a uniform scale that designates said torque level based upon said air-pressure level existing within said first and second housings during operating conditions.

14. The device of claim 11, wherein said male coupling is removably conjoined to said first housing.

15. The device of claim 11, wherein said turn dial includes a pointer imprinted thereon.
